(19) United States
(12) Patent Application Publication
(10) Pub. No.: US 2014/0214430 A1
(43) Pub. Date: Jul. 31, 2014

(54) REMOTE CONTROL SYSTEM AND DEVICE

(71) Applicant: Zhipei WANG, New Territories (HK)

(72) Inventor: Zhipei WANG, New Territories (HK)

(21) Appl. No.: 14/164,021

(22) Filed: Jan. 24, 2014

(30) Foreign Application Priority Data
Jan. 25, 2013 (HK) 13101160.7

(51) Int. Cl. G10L 21/10

(52) U.S. Cl. CPC G10L 21/10
USPC 704/275

(57) ABSTRACT

The present invention is for a system, method and device which provides a command signal corresponding to voice commands of a user. The invention includes an audio acquisition device for receiving an audible signal including a command and providing an electrical signal to a processor. The processor generates commands according to predetermined criteria, based on auditory association between the command of the plurality of commands. A visual display device displays a plurality of indicia, and a user operable selection and input device provides for user selection of commands by selection of the indicia corresponding to the command.

### FIELD OF THE INVENTION

The present invention relates to generally to remote control systems and more specifically to voice control systems and methods for operation of digital devices.

### BACKGROUND OF THE INVENTION

As digital devices incorporating software and hardware have become more prevalent in modern society, the interaction between the users and the software and hardware of these devices is becoming more critical. These digital devices range from traditional desktop computers, laptop computers, telecommunication devices, ‘smartphones’ and tablet computers and smart televisions to portable digital music players and gaming consoles.

Electrical-mechanical input through the operation of a mouse or keyboard, hand held controller or keypad (or more recently) through contact with a touch-screen are common ways in which the intentions of a user are communicated by the user to the software and hardware operating on the device. The intent of the user to change the state of device in some way so as to execute a command, display a keystroke or perform a change in program status in the device is facilitated through this input means. However, issuing commands to a digital device through contact based methods may not be appropriate or efficient for certain users or devices. Furthermore, physical control of the input can interfere with a user's experience of the device. As an alternative to physical contact based input arrangements, or in conjunction with the above arrangements, voice control technology has been utilised. One major problem common to most voice control based methods of human-device interaction lies in accurately processing the input provided by users so as to determine a corresponding command for execution on the digital device.

Commonly, words are pronounced differently by different users; and even the pronunciation of words by the same user is not always consistent over time. Individual variations in various factors in a user's voice including tone, speed and volume all mean that a word of a user can be interpreted by voice processing algorithms to mean potentially a number of different words; and therefore cause the electronic device to execute potentially a range of commands/inputs corresponding to the detected words.

Although algorithms and technology for processing speech are continually improving, many commercial products available are characterised by inaccurate or incorrect identification by the voice processing system of the information contained in the speech of a person. This is of particular importance when the speech contains commands which are issued by the user to the device to control the operation of that device. Even a relatively small failure rate or infrequent error when detecting voice commands and determining appropriate command for execution can significantly reduce user trust and acceptance of voice control technology.

Particularly for voice control technology, in which commands are issued by the users for a particular mode of execution on the system, it is necessary that the users are able to trust in the system to respond accurately each time, and every time. Occasional or sporadic failures reduce the actual and perceived reliability of the system, especially where irreversible or significant system commands are being issued using a voice control system. Loss of confidence in the accuracy of the system can in turn lead to users seeking some other means to interact with the system other than voice, as it is perceived more responsive and reliable.

Typically, current voice operated technology processes utilise information such that a user speaks, the speech is analysed and a command determined to correspond with the analysed speech is executed. However, the command may be not what the user has identified, which means that an appropriate command is not executed on the device. Alternatively, analysis of the user's speech may result in the absence of any detected command; in which case the device will not operate. Either of outcomes leads to increased frustration for the user; as they are unable to control the device so as to ensure it performs the command that is actually spoken by the user.

The present invention is designed to substantially ameliorate or at least reduce the above deficiencies in operation of users' voice operation of digital devices.

### OBJECT OF THE INVENTION

Accordingly, it is an object of the present invention to overcome or at least at least partially alleviate at least some of the deficiencies associated with the prior art.

### SUMMARY OF THE INVENTION

Broadly speaking, the present invention has described a remote control system and device.

According to a preferred embodiment of the present invention, there is provided a system for providing a command signal corresponding to a user specified command, said system comprising;

an audio acquisition device having an input for receiving an audible signal from a user and having an output for providing an electrical signal responsive to said audible signal, wherein the audible signal includes the user specified command therein;

a processor for receiving said electrical signal from the audio acquisition device, and for generating a plurality of commands according to a predetermined criteria based upon said electrical signal, wherein said predetermined criteria is an auditory association between said user specified command and said plurality of commands;

a visual display device for displaying a plurality of indicia, wherein each command of the plurality of commands is represented by an indicia of said plurality of indicia; and

a user operable selection and input device for user selection of said user determined command from said plurality of commands by selection of the indicia corresponding to said user determined command.

Optionally the visual display device may be located remote from the user. The audio acquisition device, visual display device, processor and the user operable selection and input device may be provided as discrete components from each other, and the audio acquisition device may be proximate to the user so as to receive said audible signal from the user.

Alternatively, the processor, and the user operable selection and input device are provided in an unitary device remote from the visual display device.

The unitary device may include the audio acquisition device.

The user operable selection and input device and the visual display device may be provided in a unitary hand held device.

The unitary hand held device may also include the audio acquisition device.

The unitary hand held device may be selected from the group including a mobile telephone device, a portable electronic data display device, a remote control device or the like.

The user operable selection and input device may be operable by physical interaction with the user and is selected from the group including operation of a mouse, operation of a keyboard, actuation of one or more command keys, sensing location of a user body part on a touch sensitive display panel of the display device, detection of spatial movement of the audio acquisition device in three dimensional space or the like.

The indicia displayed on the display device may include a base indicia and a plurality of indicia spaced apart from the base indicia, wherein the user operable selection and input device includes a motion detector for detecting motion of the device indicative of the spatial relationship between the base indicia and an indicia of the plurality of indicia such that the user determined command is selected by detection of motion of the input device indicative of the spatial relationship between the base indicia and the indicia indicative of said user determined command.

Motion indicative of the spatial relationship between the base indicia and the indicia associated with the user determined command may be selected from a displacement, a rotation, or a motion in a direction indicative of the spatial relationship between the base indicia and the indicia associated with the user determined command relative to the base indicia.

The system may be configured such that upon detection of said motion, a command signal corresponding to the user determined command is issued.

Selection of the user determined command may be confirmed by a pre-defined completion action by the user, wherein the pre-defined completion action of the user is selected from the group including activation of a user operable switch of the user operable selection and input device, motion of the user operable selection and input device in a predetermined direction, motion of the user operable selection and input device at a predetermined speed, motion of the user operable selection and input device at a predetermined acceleration or the like.

Detection of the motion of the user operable selection and input device may be initiated upon a pre-determined initiation action by a user.

Detection of the motion of the user operable selection and input device for selection of user determined command may be initiated upon activation of a switch of the device and wherein detection of the motion of the device for selection of the input parameter terminates upon detection of a pre-defined completion action.

The plurality of indicia may be arranged at least partly circumferentially about the base indicia. Alternatively, the plurality of indicia may be arranged in a circumferential arrangement about the base indicia. In yet another arrangement the plurality of indicia may be arranged to extend from the perimeter of the base indicia.

The indicia may be selected from the group of shapes including squares, pentagons, hexagons, octagons and the like.

The system may be configured such that upon user selection of one of the plurality of indicia indicative of user determined commands, a second plurality of indicia indicative of further input parameters is displayed. Optionally, the second plurality of indicia displayed are in a pre-determined relationship with the selected indicia of the first plurality of indicia.

The pre-determined relationship may be selected from a group which includes alphabetical proximity, or spatial proximity on a keyboard, alpha numeric grouping, or the like.

Optionally the device may be a hand held remote control device.

In an embodiment of the invention, the motion detector may be a gyroscopic sensor configured to produce a signal in response to angular motion relative to one or more reference axes, of the sensor. The hand held remote control device may include a motion detector configured to detect one or more parameters selected from the group including linear acceleration, angular acceleration, velocity, displacement or the like.

The system may be configured such that upon selection of a user determined command a change in one or more visual properties of the indicia corresponding to the selected user determined command is displayed on the display device.

Optionally upon selection of the user determined command at least one of an audio signal, visual signal or tactile signal may be emitted from the user operable selection and input device.

The system may further include an output from the processor for providing one or more output control signals for controlling one or more external devices. In a further embodiment of the invention there may be provide a system for providing a command signal corresponding to a user specified command that is selected from a plurality of commands according to a predetermined criteria based upon an audible signal from a user, and said predetermined criteria is an auditory association between said user specified command and said plurality of commands and wherein each command of the plurality of commands is represented by an indicia of a plurality of indicia, said system comprising;

an audio acquisition device having an input for receiving an audible signal from a user and having an output for providing an electrical signal responsive to said audible signal, wherein the audible signal includes the user specified command therein;

a processor for receiving said electrical signal from the audio acquisition device, and for generating a plurality of commands according to a predetermined criteria based upon said electrical signal,

a user operable selection and input device for user selection of said user determined command from said plurality of commands by selection of the indicia corresponding to said user determined command.

In another embodiment of the present invention there is provided a device for providing a command signal corresponding to a user specified command that is selected from a plurality of commands according to a predetermined criteria based upon an audible signal from a user, and said predetermined criteria is an auditory association between said user specified command and said plurality of commands and wherein each command of the plurality of commands is represented by an indicia of a plurality of indicia, said device comprising;

a processor for receiving an electrical signal provided from an audio acquisition device operating upon an audible signal containing a user specified command therein, and for generating said plurality of commands upon said electrical signal,
a user operable selection and input device for user selection of said user determined command from said plurality of commands by selection of the indicia corresponding to said user determined command.

The device may further comprise a visual display device for displaying a plurality of indicia.

The device may further include an audio acquisition device having an input for receiving the audible signal from the user and having an output for providing said electrical signal to the processor.

The device may be a device selected from the group including a mobile telephone device, a portable electronic data display device, a remote control device or the like.

Optionally the device may include a motion detector configured to detect one or more parameters selected from the group including linear acceleration, angular acceleration, velocity, displacement or the like. In an embodiment of the invention the motion detector may be a gyroscopic sensor configured to produce a signal in response to angular motion relative to one or more reference axes, of the sensor.

The device may be configured such that upon selection of a remotely selectable input parameter a change in one or more visual properties of the indicia corresponding to the user determined command is displayed on the display device. Upon selection of a user determined command, at least one of an audio signal, visual signal or tactile signal may be emitted from the user operable selection and input device.

In another embodiment of the invention a method of providing a command signal to a digital device, wherein said command signal corresponds to a user specified command that is selected from a plurality of commands according to a predetermined criteria based upon an audible signal from a user, said predetermined criteria being an auditory association between said user specified command and said plurality of commands and wherein each command of the plurality of commands is represented by an indicia of a plurality of indicia on a visual display device,
the method including the steps of

(i) acquiring an audible signal containing therein a user command wherein an electrical signal is provided responsive to said audible signal,

(ii) processing the electrical signal in a processor to generate a plurality of commands according to a predetermined criteria based upon said electrical signal, wherein said predetermined criteria is an auditory association between said user determined command and said plurality of commands;

(iii) displaying a plurality of indicia on a visual display device wherein said plurality of indicia each represent a command of the plurality of commands,

(iv) selecting a command from the plurality of commands by selecting an indicia of the plurality of indicia displayed by the visual display device; wherein said indicia is selected by physical interaction by the user with an input device.

Optionally the method may be carried out upon an input device selected from the group including operation of a mouse, operation of a keyboard, actuation of one or more command keys, sensing location of a user body part on a touch sensitive display panel of the display device, detection of spatial movement of the audio acquisition device in three dimensional space or the like.

When performing the method the selection of a command from the plurality of commands may be performed by selection of indicia of the plurality of indicia by detection of spatial movement of the input device by a user indicative of the spatial relationship between the base indicia and the indicia indicative of said user selected command.

### BRIEF DESCRIPTION OF THE DRAWINGS

Preferred embodiments of the present invention will be explained in further detail below by way of examples and with reference to the accompanying drawings, in which:—

FIG. 1 shows an exemplary schematic diagram of a system for voice controlled remote control interaction with a digital device.

FIG. 2 shows a schematic diagram of an embodiment of the system for interaction with an electronic device including a display.

FIG. 3a shows an exemplary schematic representation of a system in which an embodiment of the remote control device of the present invention utilises a motion detector for confirmation of the detected voice command.

FIG. 3b shows an exemplary schematic representation of a system in which an embodiment of the remote control device of the present invention utilises a user-actuated switch for confirmation of the detected voice command.

FIG. 4 shows an exemplary representation of a remote control device according to an embodiment of the present invention in use for operation of a display device.

FIG. 5a-5b show an exemplary series of displays which may be depicted on the display device of FIG. 4 for a one level selection.

FIG. 5c-5e show an exemplary series of display which may be depicted on the display device of FIG. 4 for nested selection.

FIG. 6 is a further exemplary display which may be depicted for confirmation by the user once a voice command is detected FIG. 7a and FIG. 7b show an exemplary process control diagram

### DETAILED DESCRIPTION OF THE PREFERRED EMBODIMENTS

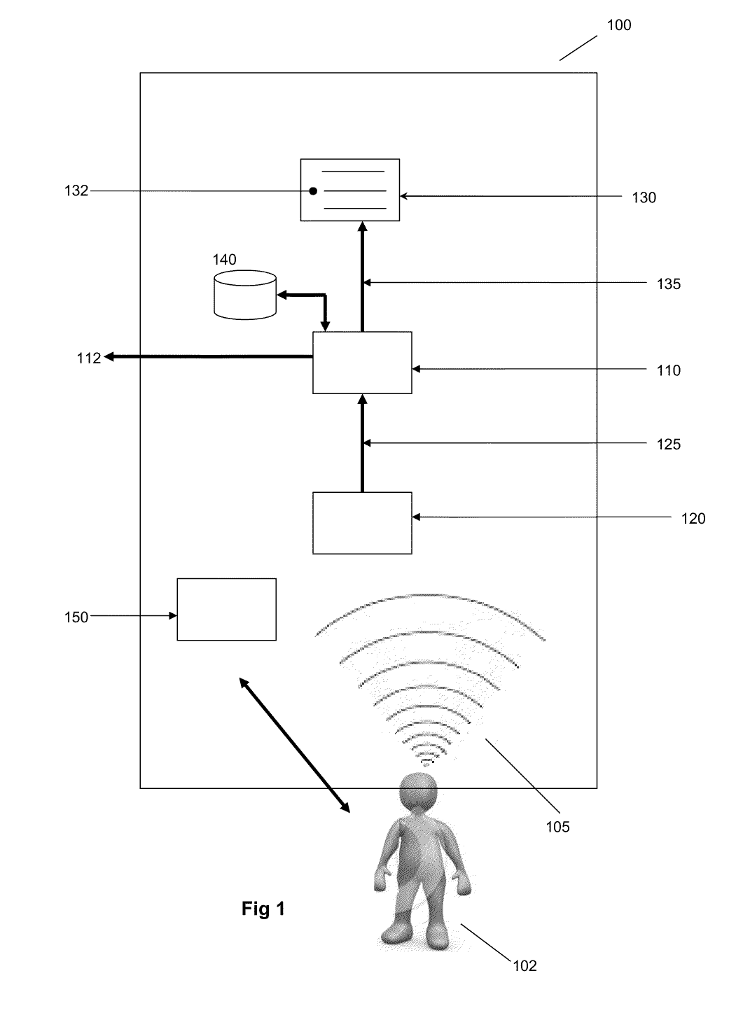

Referring to FIG. 1, there is shown an exemplary schematic diagram of a system 100 according to the present invention.

The system 100 provides for interaction between a processor 110 for issuing command signals 112 corresponding to spoken user commands 105. The user 102 is located external of the system but is able to interact with the system. The spoken user commands 105 may be detected by a microphone 120 or other device for capturing audible signals and converting such audio signals into an electrical signal 125 in a manner known to persons skilled in the art.

On the basis of the electrical signals from the microphone, the processor 110 may be configured to generate a plurality of possible commands 135 which may correspond to the electrical signal 125, displaying such plurality of commands on a visual display device 130 for user confirmation and selection based upon a predetermined criteria or lookup of a database 140 in communication with the processor 110. Included in the plurality of commands displayed on the display is the user desired command 132

The system 100 further comprises a user operable selection and input device 150 which is located proximate the user and which is configured for capturing user input and confirmation of selected commands. In particular embodiments, the input device 150 may be configured to select one command from the plurality of commands displayed on the visual display device 130.

The visual display device 130 may be located either proximate to or remote from the user and may display a potential plurality of commands 135 generated by the processor 110 according to predetermined criteria from the spoken user commands 105 based upon the electrical signal 125, including a visual representation 132 of the actual user specified command signal 112.

The user specified command signal 112 may cause the processor 110 to perform an action which effects a change to one or more components in the system shown, such as change a channel on the visual display device 130, change the input to the visual display device.

Alternatively, and as known to persons skilled in the art, the command signal 112 may instead be passed to another system, such as a lighting control system for a home environment. This system may be proximate to (or can even be located remote from) the user. It would be appreciated by a person skilled in the art, that once the user specified command signal has been generated and confirmed as being correct through operation of the user operable selection and input device, execution of the actual issued command signal 112 may be implemented by a plurality of processors external (or internal) of the system to perform various tasks including turning on/off a light switch, opening a door, changing the channel on a television, turning on air-conditioning, turning off a coffee machine or the like. It would be appreciated that the actual outcome of the execution of the command signal issued by the system of the present invention is not limited in any way.

The system may be configured such that the visual display device 130 (such as a television) may be located on the wall or on a display stand, while the microphone 120, processor 110 and user selection device 150 may be located in the same physical unit, which may be a hand held remote control device which may be retained by the user in hand for speaking and confirmation of the command by the user.

Alternatively, the system may be configured such that the visual display device 130 is also located in the same physical unit as the microphone 120, processor 110 and user selection device 150 such as a mobile phone, smart phone, data tablet device, computer or the like which may be held by the user. In this arrangement, the actual issued command signal may change the actual state of the mobile phone itself, responsive to the user's spoken commands. Alternatively, the actual issued command signal may be communicated from the mobile phone to another processor for execution on that processor.

Still further, the microphone 120 for capturing the audible signal 105 from the user 102 may be located in the walls or ceiling of the room, for detection of the audible signals issued by the user speaking to the room. Either using a user selection device such as a remote control device, a digital display device or even a mobile phone, the user may be able to confirm the spoken command from a plurality of displayed commands which are displayed to user.

The user may provide confirmation of the specified command from the plurality of user specified commands generated by the processor through physical interaction with the user input selection device. This interaction may include operation of a mouse, keyboard, actuation of one or more command keys, sensing the location of a user body part on a touch sensitive display panel of the device or in other human-computer interactions other than voice known to persons skilled in the art. Alternatively, in a further embodiment of the present invention outlined below, the interaction with the device may be through the detection of spatial movement of the user selection device.

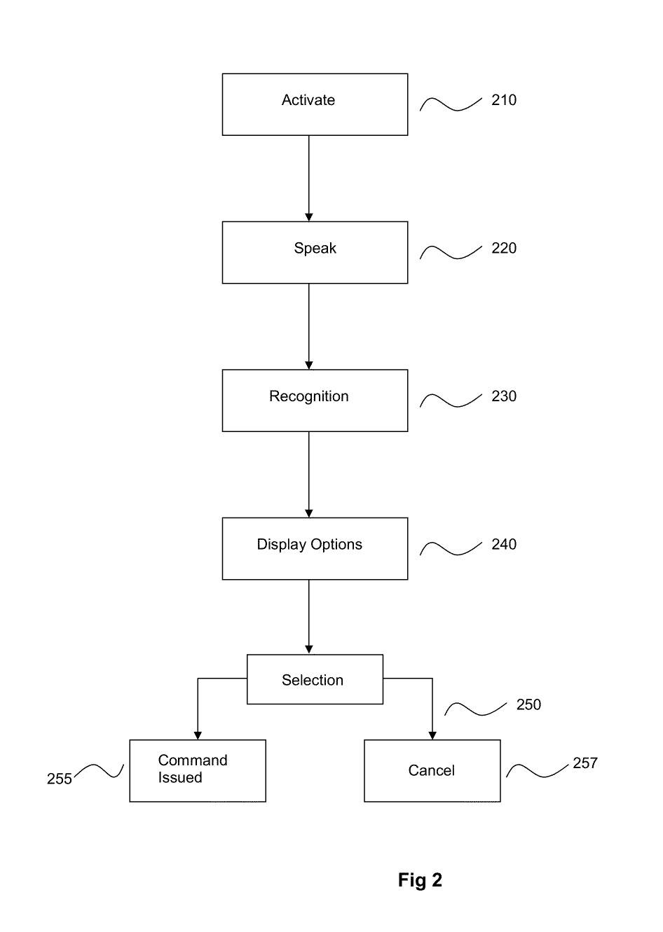

FIG. 2 shows an exemplary flow chart detailing typical steps in the interaction with an embodiment of a system according to the present invention.

The system of the present invention may be activated 210 by the user by a pre-determined initiation action by the user such as activation of a switch or a particular detectable motion of the device, or the issuance of a very specific keyword with unique characteristics, and which may be detectable by the system. In a particular embodiment, the system may be triggered to enter an active state through motion of the device in a pre-determined direction, speed, acceleration of combinations thereof.

Once the device has been activated, the user may speak 220 their desired command to the system, which is detected through a microphone or other audio acquisition device. This acquisition device is responsible for capturing the analogue sound waves of the user's voice and transforming them into an electrical signal representative of such, in a processor known to persons skilled in the art.

The recognition 230 of the command signal is performed using conventional voice matching algorithms, which process the digitized voice features extracted from the signal using such processing as MFCC. Once features have been identified from the voice signal, these features are matched (either remotely across the network or on the actual device) with corresponding features of certain commands. Matching algorithms such as Dynamic Time Warping algorithm using Dynamic Programming Techniques, or other techniques such as Liner Predictive Coding, Hidden Markov Model and Artificial Neural Network based matching approaches may also be utilised without detracting from the scope of the present invention. It would be appreciated by a person skilled in the art that the above does not constitute an exhaustive list, and other specific algorithms could also be utilised.

This recognition process may be performed by the processor by consulting a database, or using complex sound processing algorithms such as the above to determine potential commands which may correspond to the signal provided by the user. The matching may be carried out against a library of commands stored on a database which have been previously supplied by the user in a training process or the like, or may be performed based upon a matching process against a sample supplied by the user.

Accordingly, Commands which may correspond to the user specified command are displayed 240 to the user for their confirmation. Advantageously, the degree of ‘matching’ that is exhibited by the command may be used to order the list, from the highest match to the lowest match for presentation to the user.

This display may be located remote from the user on a separate display device or may be located proximate to the user, for example in a hand held display device, such as a tablet device, computer or smart phone device.

The user is able to select 250 from the plurality of the commands which are displayed as possible matches, and is able to confirm their selection through interaction with the system other than by speaking. Such forms of human computer interaction are well known to persons skilled in the art and may include operation of a mouse, operation of a keyboard, actuation of one or more command keys, sensing location of a user body part on a touch sensitive display panel of the display device, detection of spatial movement of the audio acquisition device in three dimensional space or the like.

Once the selection 250 of the user specified command from the plurality of possible commands has been made, the command may be issued 255 to the processor within the system to perform a particular task corresponding to that command signal. Alternatively, the command signal 255 may be issued to a processor external of the system so as to cause that processor to perform some action or execute some predetermined process. Alternatively, if the command signal has not been correctly identified by the system despite the presentation to the user of a plurality of options, the user may elect to cancel the issuance of the command 257, and begin the process again.

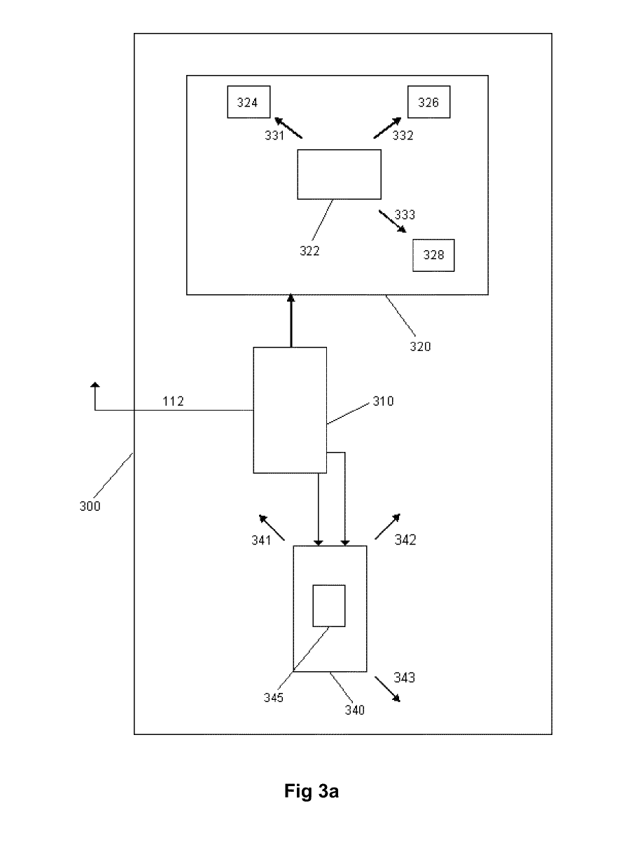

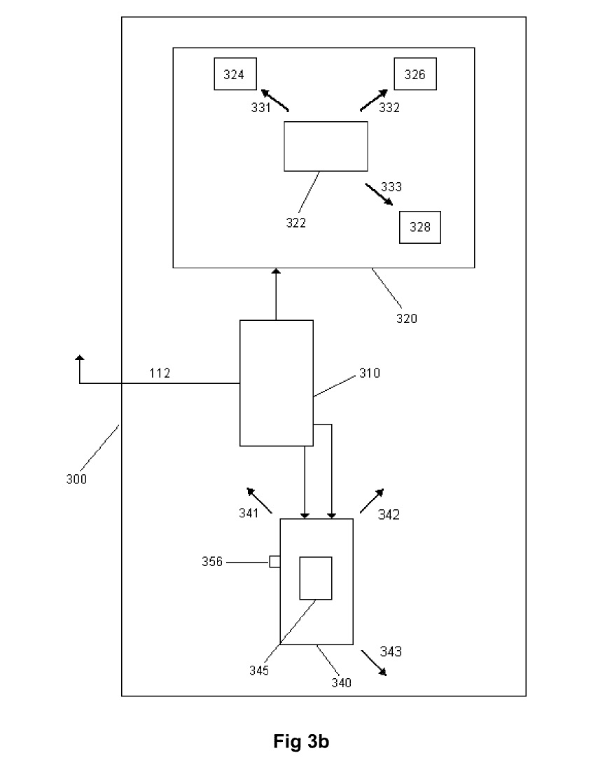

Turning to the system depicted by FIG. 3a, a specific embodiment of the voice control remote operation of a device is described in operation with a remote control device which operates by detecting motion of the remote control device. This embodiment is described to provide context and is a specific implementation only of the foregoing. It would be appreciated by a person skilled in the art that other implementations are possible, wherein the interaction with the system is not mediated through motion of the remote control device, as has been described above; and in contrast to the description of the specific embodiment which follows.

The system 300 comprises a remote visual display device 320 for displaying base indicia 322 and a first plurality of indicia 324,326, 328 spaced apart from the base indicia 322. The base indicia 322 and the first plurality of indicia 324, 326, 328 are displayed on the visual display device so that a user may remotely confirm such indicia. The indicia are indicative of potential corresponding commands which have been determined by processor 310 based upon processing of the audible signal as has been detailed above.

The system 300 further includes a user operable selection and input device 340 which provides for the user to remotely select an input parameter. The device 340 includes a motion detector 345 for detecting motion of the device 340, whereby the motion is indicative of the spatial relationship between the base indicia 322 and indicia of the first plurality of indicia 324, 326, 328.

A first command may be selected when a user moves the device 340 in a first direction 341 which is indicative of the spatial relationship between the base indicia 322 and first indicia 324, as shown by arrows 341 corresponding with the motion in the direction of arrow 331.

A user may then select a further input parameter by moving the device 340 in a direction indicative of a further input parameter as associated with a further indicia 326, as depicted by motion of the device 340 in a direction 342 corresponding to the spatial relationship of the further indicia 326 from the base indicia 322 as shown by corresponding arrow 332.

Similarly, yet further selections may be made by a user by moving the device 340 in the direction 343 which corresponds with the spatial relationship of the yet further indicia 328 as disposed from the base indicia 322 as shown by arrow 333.

As will be understood, the selection of a command of the plurality of commands is based on the relative motion of the device 340 with respect to the represented spatial relationship of selection indicia with respect to a base indicia 322 as shown on the visual display device. Irrespective of where the device 340 is in three-dimensional space, the fact to movement of the device 340 as corresponding to the spatial disposition between further indicia and the base indicia 322 are upon which selection of such command from the plurality of commands are based. A person skilled in the art will appreciate that the movement of device may also be only in two dimensional space, such as movement on a desktop.

Accordingly, irrespective of the position of the device 340, selection of a first indicia may also be followed by selection of a further indicia by vectorial motion corresponding to the disposition of indicia as correlating with a requisite command.

The motion of device 340 for selection of indicia may be displacement, rotation, or alternatively combinations thereof.

Those skilled in the art will appreciate that upon completion of a motion in a direction towards a requisite indicia relating to a required command confirmation of a pre-defined action by a user for selection of a requisite command may be provided in various manners, without departing from the scope of the invention.

In an embodiment of the invention, completion of an action may be determined by a further motion of the device 340 other than that in the direction of an indicia.

Alternatively, completion of the action by a user may include activation of a user operable switch, motion of the device in a pre-determined direction, motion of the device at a pre-determined speed, motion of the device at a pre-determined acceleration or the like, or combinations thereof. Still further, the user may be able to provide input to the system using other modes of human computer interaction, including through the operation of a button, mouse, keyboard, user location of a body part on the a touch sensitive screen or the like. The means by which confirmation is provided can potentially be existing human computer interface technology other than voice operated detection.

An exemplary mode of operation of a touch screen portable electronic device such as a smart phone or tablet computer is discussed. In this embodiment, using the voice/touch screen operation modes together, a user may touch a region of the screen corresponding to a “voice” button, which activates the voice recognition engine. The screen advises information to the user that the voice command mode has been entered through display of an indicia or change in colour etc. A detected end of the command or sequence of commands is indicated, and/or confirmed by the user depressing the voice button.

After the voice command has been detected, and potential candidates have been identified for user confirmation, the possible selections of commands determined by the voice recognition engine may be displayed about the “voice” button for confirmation by the user by sliding and releasing their finger from contact with the smart phone or tablet computer. It would be appreciated that further alternative display arrangements would be possible.

Further, detection of commencement of motion of the remote control device 340 may be initiated by a pre-determined initiation action by the user such as activation of a switch or a particular detectable motion of the remote control device 340 as depicted by the representation shown in FIG. 3b or through detected movement on a touch screen surface (not shown).

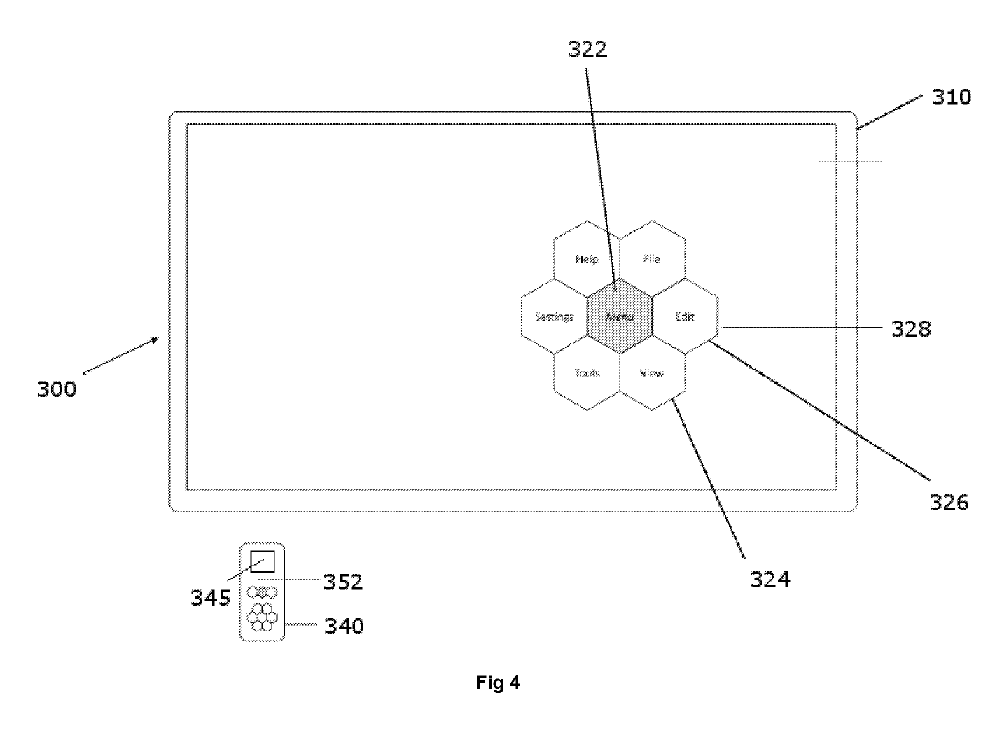

Referring to FIG. 4, an exemplary embodiment of the system of the present invention is depicted 200, in which the user operated remote control device 340 is used for operation of the display device, 310 which may be a television, or computer screen or the like. The user operated remote control device 340 may include one or more buttons 342. These buttons may be arranged similarly to those displayed on the screen 210; buttons arranged in another arrangement for actuation by a user or may alternatively include a small display screen which is located on the controller itself.

As such, the remote control device may be a mobile telecommunications device such as a smart phone, or tablet computer or the like on which a program for remote control of the display unit is operational.

In this embodiment, a first plurality of indicia 324, 326, 328 are displayed on the display 210 and arranged in a spaced apart and partially circumferential relationship with reference to the base indicia 322 and displayed on the display.

Accordingly, motion of the remote control device 350 in a direction towards one of the plurality of indicia 324, 326, 328 from the base indicia 322 may be cognitively determinable by a user such that the motion coincides with the vectorial spatial disposition of an indicia of the plurality of indicia 324, 326, 328.

In other or alternate embodiments, the plurality of the indicia 324, 326, 328 may extend circumferentially around the base indicia, and may be equally spaced apart from each other.

Further, the plurality of indicia may be contiguous or extending from the parameter of a base indicium or indicator. The geometry and shape of the indicia may be selected from a group including squares, pentagons, hexagons, octagons or the like.

Those skilled in the art will appreciate that the spatial relationship and number of indicia will affect the cognitive process of a user in relative motion so as to select indicia, and depending upon the resolution of the visual display device as well as the resolution and detection quality of the movement of the device 340.

The device 340 may include a motion detector 345 for detecting motion of that device 340, whereby the motion is indicative of the spatial relationship between the base indicia 322 and indicia of the first plurality of indicia 324, 326, 328.

In other embodiments, selection of one of the first plurality of indicia may activate a second plurality of indicia which are indicative of further input parameters, and these may be displayed on the visual display device 320 accordingly as shown in Figure The display of the second plurality of indicia may be displayed in a pre-determined relationship with the first plurality of indicia, based on cognitive function, standards, ease of interpretation or the like, for example, a pre-determined relationship may be that of alphabetical proximity, spatial proximity on a keyboard, alphanumeric grouping, grouping and cognitive selection in the language of use or the like.

The indicia 324, 326, 328 as displayed on the visual display device 320 may be highlighted upon selection so as to enhance cognitive spatial perception by a user when using the device and selecting important parameters. Confirmation of the selection of a command may be indicated by feedback to a user, such as an audio signal, visual signal, tactile signal emitted from the device 340 or the like.

Where the remote control device 340 includes a motion detector 345, the motion detector 345 may be configured to detect one or more spatial movement parameters including linear acceleration, angular acceleration, velocity, displacement or the like.

The processor (not shown) may be in communication with the device 340 by way of wireless communication, such as radio frequency transmission, infrared or optical communication, Bluetooth type communication or the like.

The processor (not shown) may be in communication with the visual display device 310 by way of wired connection. Alternatively, those skilled in the art will appreciate that the communication between the processor and the visual display device 310 may be way of wireless communication.

Further, as will be appreciated by those skilled in the art, the processor then may be incorporated within the device 340, in the display screen 310 or at some other location in the system.

Upon selection of a requisite input parameter, the processor may provide an output signal to a further device external of the system, depending upon the application of the system.

Further, those skilled in the art will appreciate that motion may be detected by a user by alternate methods such as an external optical in each acquisition system, capable of ascertaining movements and directions of motion of a user, and thus allow a user to select indicia and hence activate requisite input parameters without physical contact with a device 350.

Those skilled in the art will appreciate that the present invention provides for ease of cognitive identification of input parameters and selection thereof based upon an indicia which, upon detection of an appropriate vectorial movement by a user corresponding to a spatial displacement of a corresponding indicia to a base indicia, allows ease of selection.

Furthermore, irrespective of the location of the device 340, the movement of the device 340 in a direction corresponding to that of the vectorial displacement of an indicia with respect to a base indicia provides for ease of input and selection by a user.

Still further, those skilled in the art will appreciate that a lower amount of computational power is required, as motion of the device 340 need only be determined upon activation of the device for commencement of a movement indicative of selection of a indicia and hence command, thus simplifying a process of selection of subsequent indicia for subsequent command selection.

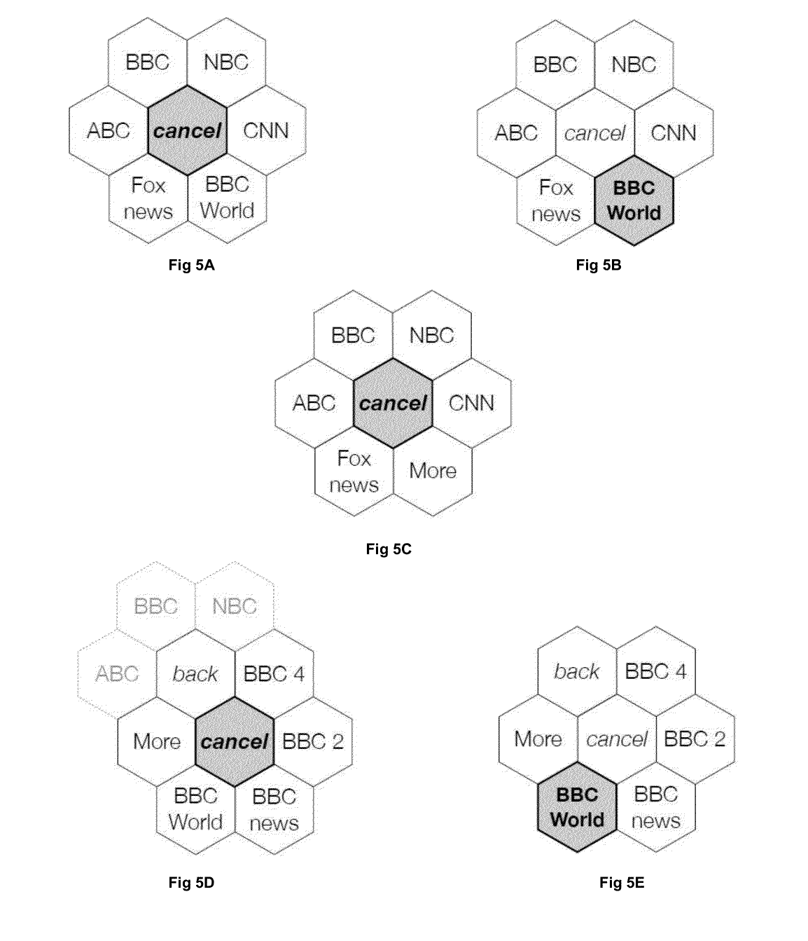

Referring to FIG. 5a-5e, there is presented an exemplary mode of operation of the system depicted in FIG. 4, using an embodiment of the motion sensitive remote control device discussed previously.

The voice controlled operation mode of the system may be initiated through issuance of a particular command, actuation of a button or the provision of some other input to the system. After initiation of the correct mode, the user may then speak the command that the user wishes the system to perform. The speech of the user may be captured by a microphone and then passed to a processor which provides a plurality of possible commands which could potentially correspond to the spoken command for confirmation, as described above.

As depicted these commands may be presented with an active indicia being displayed at the base position, and corresponding to the position of the remote control device in three dimensional real space before being moved by the user. The active indicia may be made visually distinct to the user, including by changing colour, shading (as shown) or by enlarging the text and/or background of the base indicia or other similar techniques as will known to persons skilled in the art.

Once the on screen display is activated by a user, the remote control device 350 may be used by the user to select a command to be performed by the processor as shown by FIGS. 5a-5c.

The active indicia 372 shown in FIGS. 5a-5c may be representative of the best or primary match to the spoken command determined by the processor using voice recognition algorithms. Alternative commands 374 which may sound similar to or have a context specific relationship with the spoken command may also be displayed about the base active indicia 372. These indicia may be arranged in a specific spatial relationship about the base indicia.

As shown on the display, the “BBC World” indicia is located to the bottom left of the central “cancel” indicia; while the “BBC” indicia is located diagonally up and to the left relative to the central indicia. This spatial relationship is important for operation of an embodiment of the present invention, wherein confirmation of the user selection is provided by movement of the user operated remote control device in three dimensional space.

By actuation of the switch button of the remote control device, a processor may be configured to begin capture of position information of the device in three dimensional space.

In order to confirm a detected “BBC world” command for operation by a processor of the system, in the exemplary embodiment the user may move the remote control device to the bottom right; to select the indicia corresponding to “BCC world” and make that the active indicia. Since the direction of the indicia relative to the base position is to the bottom right position, the user moves the device to the bottom right position to change the active indicia.

Upon the active indicia of the display changing to “BBC World” in accordance with the user's motion of the device in three dimensional space, the user may release the switch button of the remote control thereby causing the settings command to be issued to the processor by the remote control device.

Confirmation that a command has been issued to the processor by the remote control device may be provided by an audio signal, visual signal or tactile signal is emitted from the user operable selection and input device. Alternatively, confirmation may be provided by a change in one or more visual properties of the indicia corresponding to the selected input parameter is displayed on the display device.

In the exemplary embodiment depicted in FIGS. 5a-5b, there is shown an optional ‘nested’ arrangement in which the user may speak a first command (“BBC World”), display indicia corresponding to a plurality of related commands 374, as well as indicia corresponding the BBC world command 375. As shown in FIG. 5c, 5d, the selected indicia may be accessed from a further level, upon selection of the “More” option. Once this indicia is selected further menu options may be provided as shown in FIG. 5d, 5e for confirmation by the user. In both embodiments depicted in FIGS. 5a-5e, confirmation by the user of the spoken command may be achieved through a confirmation motion, then speak a second command (“NEW”),

This interaction mode could be tedious if too many levels of nesting are employed; and as such it is illustrative of how the system of the present invention may be configured and it is important that appropriate levels of nesting are utilised.

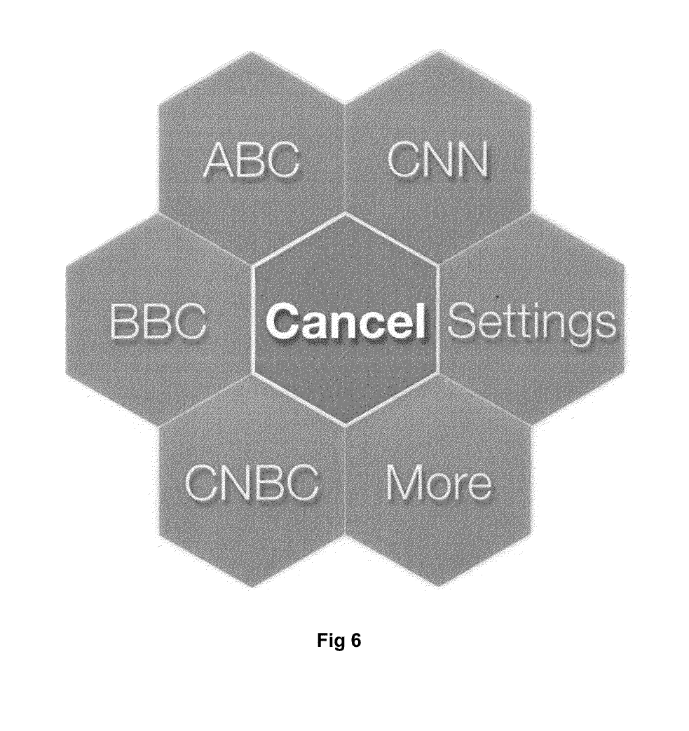

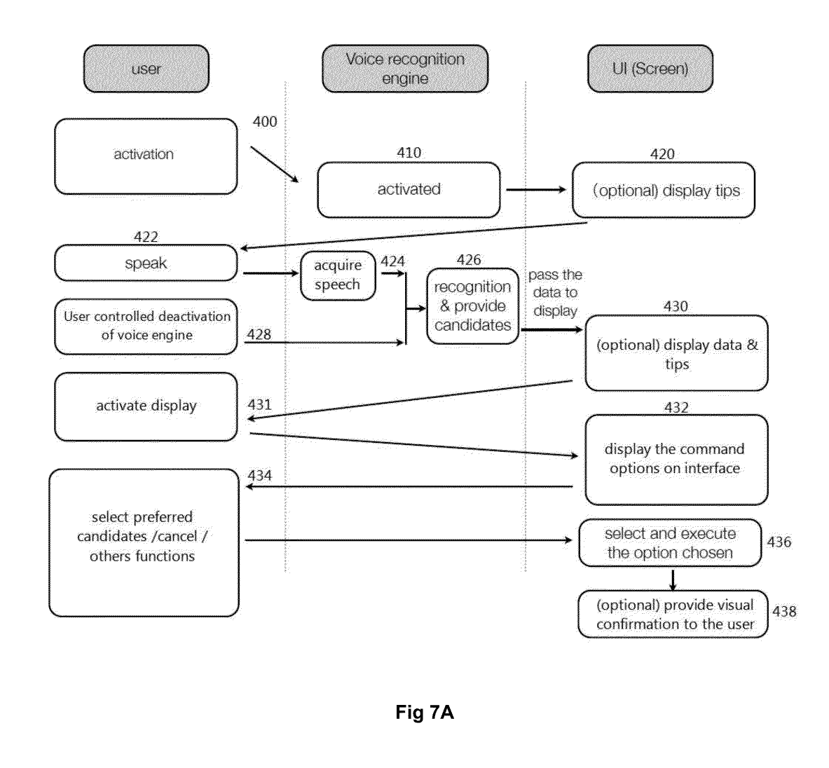

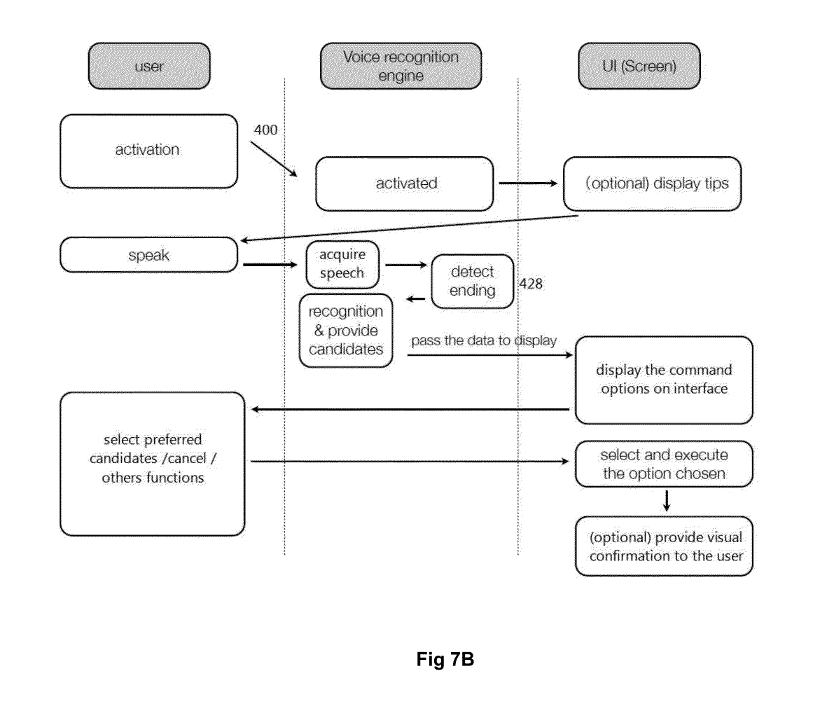

FIG. 6 depicts a further display of indicia that may be presented for selection by a user, based upon a spoken command “CNN”. The displayed indicia may be based upon the voice recognition software process or some other relationship between the speech of the user and possible commands that may be displayed. The displayed indicia may be arranged about the base indicia and similarly the spatial relationship in three dimensional space may be representative of motion of the remote control device required for confirmation of the appropriate command. It would be appreciated that the displayed indicia of FIG. 6 are merely one way in which the indicia may be presented, and not determinative in any way.

FIG. 7a, 7b represent a control diagram showing the way in which control passes between the user, the voice recognition engine and device incorporating a user interface according to an exemplary embodiment of the present invention.

As shown, the user activates the device 400, which changes the voice recognition engine 410 into a ready state, awaiting input. Display on the user interface may indicate the change in status of the device 420. Upon speech being detected 422, this speech is acquired and passed to the voice recognition engine 424, where it is recognised and potential candidates for the commands are determined 426. The end of the detection state of the device 428 may be triggered either manually by the user (as shown in FIG. 7a) or automatically (as shown in FIG. 7B).

The user may be asked to activate the device again through the inclusion of a message on the user interface 430, which can then be performed by the user 431. Alternatively, the user may be simply presented with the alternative candidates for the commands on the user interface. These may be ranked according to the degree of “matching” of the detected voice signal against previously stored commands. Alternatively, another ranking/ordering approach may be employed without detracting from the scope of the present invention.

The user may select from the displayed possible commands which corresponds to their intended actual command to be performed as shown in 434; in a variety of ways, including voice/touch or other selection process as noted above.

The user selection may then be passed back to the user interface form selection and execution on the local device or on the system remote from the device. (436) Optionally, visual feedback may be provided to the user verifying the command that was performed (438), or the command may simply be performed without such confirmation.

FIG. 7b is substantially the same as FIG. 7a, except that the end of the speech of a user is automatically detected in the system shown. For example, the voice recognition engine may be configured to detect the absence of voice, or sound.

As would be understood by persons skilled in the art, the present system provides for an enhanced level of accuracy when compared with existing prior art voice control systems. Because the detected voice commands are independently verified by the user, if an inaccurate command is processed based upon the detected voice signals, the user is able to intercept and/or correct this command before it is actually executed by the system. This increases significantly the level of trust that the user has in the system, which in turn enhances the user adoption of the voice control operation mode of such devices in view of the perceived increase in reliability.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

For example, the remote control device located proximate the user may be a unitary hand held device in which some or all of the components of the system are contained. In particular, the remote control device may include a mobile telephone device, a portable electronic data display device such as a tablet, a remote control device with our without a display or the like without detracting the scope of the present invention.

1. A system for providing a command signal corresponding to a user specified command, said system comprising;
an audio acquisition device having an input for receiving an audible signal from a user and having an output for providing an electrical signal responsive to said audible signal, wherein the audible signal includes the user specified command therein;
a processor for receiving said electrical signal from the audio acquisition device, and for generating a plurality of commands according to a predetermined criteria based upon said electrical signal, wherein said predetermined criteria is an auditory association between said user specified command and said plurality of commands;
a visual display device for displaying a plurality of indicia, wherein each command of the plurality of commands is represented by an indicia of said plurality of indicia; and
a user operable selection and input device for user selection of said user determined command from said plurality of commands by selection of the indicia corresponding to said user determined command.

2. A system for providing a command signal corresponding to a user specified command according to claim 1 wherein the visual display device is remote from the user.

3. The system for execution of a user determined command according to claim 1 wherein the audio acquisition device, visual display device, processor and the user operable selection and input device are provided as discrete components from each other, and the audio acquisition device is proximate to the user so as to receive said audible signal from the user.

4. A system for providing a command signal corresponding to a user specified command according to claim 1 wherein the processor, and the user operable selection and input device are provided in an unitary device remote from the visual display device.

5. A system for providing a command signal corresponding to a user specified command according to claim 4 wherein said unitary device further includes the audio acquisition device.

6. A system for providing a command signal corresponding to a user specified command according to claim 1 wherein the processor, the user operable selection and input device and the visual display device are provided in a unitary hand held device.

7. A system for providing a command signal corresponding to a user specified command according to claim 6 wherein said unitary hand held device further includes the audio acquisition device.

8. A system for providing a command signal corresponding to a user specified command according to claim 6 wherein the unitary hand held device is selected from the group including a mobile telephone device, a portable electronic data display device, a remote control device or the like.

9. The system of claim 1 wherein the user operable selection and input device is operable by physical interaction with the user and is selected from the group including operation of a mouse, operation of a keyboard, actuation of one or more command keys, sensing location of a user body part on a touch sensitive display panel of the display device, detection of spatial movement of the audio acquisition device in three dimensional space or the like.

10. The system according to claim 1 where the indicia displayed on the display device include a base indicia and a plurality of indicia spaced apart from the base indicia, wherein the user operable selection and input device includes a motion detector for detecting motion of the device indicative of the spatial relationship between the base indicia and an indicia of the plurality of indicia such that the user determined command is selected by detection of motion of the input device indicative of the spatial relationship between the base indicia and the indicia indicative of said user determined command.

11. A system according to claim 10, wherein said motion indicative of the spatial relationship between the base indicia and the indicia associated with the user determined command is a selected from a displacement, a rotation, or a motion in a direction indicative of the spatial relationship between the base indicia and the indicia associated with the user determined command relative to the base indicia.

12. A system according to claim 1, wherein upon detection of said motion, a command signal corresponding to the user determined command is issued.

13. A system according to claim 1 wherein selection of the user determined command is confirmed by a pre-defined completion action by the user, wherein the pre-defined completion action of the user is selected from the group including activation of a user operable switch of the user operable selection and input device, motion of the user operable selection and input device in a predetermined direction, motion of the user operable selection and input device at a predetermined speed, motion of the user operable selection and input device at a predetermined acceleration or the like.

14. A system according to claim 1, wherein detection of the motion of the user operable selection and input device is initiated upon a pre-determined initiation action by a user.

15. A system according to claim 14, wherein detection of the motion of the user operable selection and input device for selection of user determined command is initiated upon activation of a switch of the device and wherein detection of the motion of the device for selection of the input parameter terminates upon detection of a pre-defined completion action.

16. A system according to claim 1, wherein the plurality of indicia are arranged at least partly circumferentially about the base indicia.

17. A system according to claim 1, wherein the plurality of indicia are arranged in a circumferential arrangement about the base indicia.

18. A system according to claim 17, wherein the plurality of indicia extend from the perimeter of the base indicia.

19. A system according to claim 1 wherein the indicia are selected from the group of shapes including squares, pentagons, hexagons, octagons and the like.

20. A system according to claim 1 wherein upon user selection of one of the plurality of indicia indicative of user determined commands, a second plurality of indicia indicative of further input parameters is displayed.

21. A system according to claim 20 wherein said second plurality of indicia displayed are in a pre-determined relationship with the selected indicia of the first plurality of indicia.

22. A system according to claim 21 wherein the pre-determined relationship is selected from a group which includes alphabetical proximity, or spatial proximity on a keyboard, alpha numeric grouping, or the like.

23. A system according to claim 1 wherein the device is a hand held remote control device.

24. A system according to claim 1 wherein the motion detector is a gyroscopic sensor configured to produce a signal in response to angular motion relative to one or more reference axes, of the sensor.

25. A system according to claim 24 wherein the hand held remote control device includes a motion detector configured to detect one or more parameters selected from the group including linear acceleration, angular acceleration, velocity, displacement or the like.

26. A system according to claim 1 wherein upon selection of a user determined command a change in one or more visual properties of the indicia corresponding to the selected user determined command is displayed on the display device.

27. A system according to claim 1 wherein upon selection of the user determined command at least one of an audio signal, visual signal or tactile signal is emitted from the user operable selection and input device.

28. A system according to claim 1 wherein the system further comprises an output from the processor for providing one or more output control signals for controlling one or more external devices.

29. A system for providing a command signal corresponding to a user specified command that is selected from a plurality of commands according to a predetermined criteria based upon an audible signal from a user, and said predetermined criteria is an auditory association between said user specified command and said plurality of commands and wherein each command of the plurality of commands is represented by an indicia of a plurality of indicia, said system comprising;
an audio acquisition device having an input for receiving an audible signal from a user and having an output for providing an electrical signal responsive to said audible signal, wherein the audible signal includes the user specified command therein;
a processor for receiving said electrical signal from the audio acquisition device, and for generating a plurality of commands according to a predetermined criteria based upon said electrical signal,
a user operable selection and input device for user selection of said user determined command from said plurality of commands by selection of the indicia corresponding to said user determined command.

30. A device for providing a command signal corresponding to a user specified command that is selected from a plurality of commands according to a predetermined criteria based upon an audible signal from a user, and said predetermined criteria is an auditory association between said user specified command and said plurality of commands and wherein each command of the plurality of commands is represented by an indicia of a plurality of indicia, said device comprising;
a processor for receiving an electrical signal provided from an audio acquisition device operating upon an audible signal containing a user specified command therein, and for generating said plurality of commands upon said electrical signal,
a user operable selection and input device for user selection of said user determined command from said plurality of commands by selection of the indicia corresponding to said user determined command.

31. A device according to claim 30 further comprising a visual display device for displaying a plurality of indicia.

32. A device according to claim 30 wherein the device further includes an audio acquisition device having an input for receiving the audible signal from the user and having an output for providing said electrical signal to the processor.

33. A device according to claim 32 wherein the device is a device selected from the group including a mobile telephone device, a portable electronic data display device, a remote control device or the like.

34. A device according to claim 30 wherein the remote control device includes a motion detector configured to detect one or more parameters selected from the group including linear acceleration, angular acceleration, velocity, displacement or the like.

35. A device according to claim 34, wherein the motion detector is a gyroscopic sensor configured to produce a signal in response to angular motion relative to one or more reference axes, of the sensor.

36. A device according to claim 32 wherein upon selection of a remotely selectable input parameter a change in one or more visual properties of the indicia corresponding to the user determined command is displayed on the display device.

37. A device according to claim 32, wherein upon selection of a user determined command, at least one of an audio signal, visual signal or tactile signal is emitted from the user operable selection and input device.

38. A method of providing a command signal to a digital device, wherein said command signal corresponds to a user specified command that is selected from a plurality of commands according to a predetermined criteria based upon an audible signal from a user, said predetermined criteria being an auditory association between said user specified command and said plurality of commands and wherein each command of the plurality of commands is represented by an indicia of a plurality of indicia on a visual display device,
the method including the steps of
(i) acquiring an audible signal containing therein a user command wherein an electrical signal is provided responsive to said audible signal,
(ii) processing the electrical signal in a processor to generate a plurality of commands according to a predetermined criteria based upon said electrical signal, wherein said predetermined criteria is an auditory association between said user determined command and said plurality of commands;
(iii) displaying a plurality of indicia on a visual display device wherein said plurality of indicia each represent a command of the plurality of commands,
(iv) selecting a command from the plurality of commands by selecting an indicia of the plurality of indicia displayed by the visual display device; wherein said indicia is selected by physical interaction by the user with an input device.

39. A method of providing a command signal to a digital device according to claim 38 wherein the input device is selected from the group including operation of a mouse, operation of a keyboard, actuation of one or more command keys, sensing location of a user body part on a touch sensitive display panel of the display device, detection of spatial movement of the audio acquisition device in three dimensional space or the like.

40. A method of providing a command signal to a digital device according to claim 38 wherein the selection of a command from the plurality of commands is performed by selection of indicia of the plurality of indicia by detection of spatial movement of the input device by a user indicative of the spatial relationship between the base indicia and the indicia indicative of said user selected command.
